(19) United States
(12) Patent Application Publication
(10) Pub. No.: US 2023/0008301 A1
(43) Pub. Date: Jan. 12, 2023

(54) POLYMER CONETWORKS OF POLY(PYRIDINE-(METH)-ACRYLAMIDE) DERIVATIVES- CROSSLINKED BY TRANSITION METAL IONS-AND LINKED BY POLYDIMETHYLSILOXANE DERIVATIVES

(71) Applicant: LUXEMBOURG INSTITUTE OF SCIENCE AND TECHNOLOGY (LIST), Esch-sur-Alzette (LU)

(72) Inventor: Clément MUGEMANA, Arlon (BE)

(21) Appl. No.: 17/780,073

(22) PCT Filed: Nov. 27, 2020
(86) PCT No.: PCT/EP2020/083619

§ 371 Date: May 26, 2022

(30) Foreign Application Priority Data
Nov. 28, 2019 (LU) LU101497

(51) Int. Cl. C08F 290/06; C08K 3/08

(52) U.S. Cl. CPC C08F 290/068; C08K 3/08; C08K 2003/0893

(57) ABSTRACT

Metallo supramolecular polymer conetworks (MSMC) of poly[r(alkyl)ₐ-N-(pyridin-s-yl) (meth)-acrylamide moiety]_{m,n} derivatives-complexed to a transition metal cation-linked by poly(dimethylsiloxane)ₚalkyl-(meth)-acrylate moiety derivatives, wherein a is 0 or 1 or 2, p is an integer selected from the group consisting of from 50 to 70 and of from 120 to 180, r is integer of from 0 to 4, and s is an integer of from 2 to 4, and m and n, independently, are integers of from 5 to 11. These MSMC can be used as film or coating on a substrate and are exhibiting self-healing and bacterial anti-adhesion properties.

The present invention is the US national stage under 35 U.S.C. § 371 of International Application No. PCT/EP2020/083619 which was filed on Nov. 27, 2020, and which claims the priority of application LU 101497 filed on Nov. 28, 2019 the contents of which (text, drawings and claims) are incorporated here by reference in its entirety.

### FIELD

The invention is directed to the field of metallo supramolecular polymer conetworks of alkyl)a-N-(pyridin-s-yl) (meth)-acrylamide moiety poly(pyridine-vinyl groups directly attached to a carbonyl carbon derivatives)-linked by polydimethylsiloxane derivatives and loaded with transition metal complexes type compounds (MSMC) for use as a film or coating on a substrate, to a method of preparation thereof and to applications in the medical field.

### BACKGROUND

One of the outstanding features of biological systems is their ability to heal damage autonomously. Inspired by this observation, the design of man-made self-healing materials has exponentially increased over the last decade. Reversible interactions based on supramolecular interactions have often been preferred over their covalent counterparts to create self-healing materials. Among the supramolecular interactions available, metal-ligand bonds represent an attractive motif because of the possibility to tune the interaction strength by simply choosing the appropriate metal ion and ligand. In addition to self-healing feature, the use of metal complexes enlarges the properties and functionalities of the resulting materials, including but not limited to light responsive solvatochromic, conductive and highly stretchable polymers. Nevertheless, the current challenge in self-healing materials lies in design of materials that combine self-healing ability and good mechanical properties. The use of linear block copolymers or brush polymer architectures has led to self-healing nanostructured polymers with highly improved mechanical properties.

Amphiphilic polymer conetworks (APCNs) are nanostructured materials with a unique portfolio of properties, including swellability in water and in organic solvents, robust mechanical properties, optical transparency and tunable permeability. Moreover, they are easy and straightforward to synthesize. The covalently interconnected hydrophobic and hydrophilic polymer chains result in phase-separated morphologies. The mechanical properties can be adjusted by tuning the polymer composition and the chemical functionality of the polymer segments. APCNs have shown great potential for applications that range from contact lenses to separation membranes transdermal drug delivery system biomaterials for artificial pancreas, and as support materials for catalysts. Nevertheless, so far no self-healing APCNs have been reported in literature. Only self-sealing APCNs have been developed that close punctures by swelling in water (M. Rother, J. Barmettler, A. Reichmuth, J. V. Araujo, C. Rytka, O. Glaied, U. Pieles, N. Bruns, Advanced Materials 2015, 27, 6620-6624). However, they did not heal damage permanently. Therefore, hydrophilic monomers bearing a hydrophobic masking group have been used to prepare hydrophobic precursor conetworks]. They are then converted into amphiphilic materials by cleavage of the masking group, leading to phase-separated nanostructured polymer networks. Recently, pentafluorophenyl acrylate (PFPA) has been reported as a suitable hydrophobically masked monomer that simultaneously is in active ester and therefore allows to prepare a wide range of functionalized poly(acrylamide)-based APCNs (S. Ulrich, A. Sadeghpour, R. M. Rossi, N. Bruns, L. F. Boesel, Macromolecules 2018, 51, 5267-5277).

Polymer coatings provide various functionalities to different types of substrates and are inevitably exposed to mechanical loads that induce the formation of cracks leading to the loss of functionality of the coating. To ensure long-term stability and functionality, the durability must be addressed when designing new functional materials. The self-healing feature is of great interest for regenerating the inherent properties of the materials following mechanical damage. The most encountered self-healing polymer coatings lack transparency due to the concerned chemistry and the transparent ones are not covalently attached to the surface and may simply delaminates or detach over time. On the other hand, surface-attached polymer coatings do not undergo permanent healing process.

Mechanically robust transparent self-healing coatings were prepared via layer-by-layer process. The self-healing was triggered by immersing the coating in water. One of the drawbacks is the lack of stability, which can lead to the polymer etching or delamination when the coating is exposed to water or organic solvent for a prolonged period.

Intrinsic self-healing polymers have been developed to design transparent polymer using reversible covalent bonds such as imine bonds, a Schiff base reaction between amine and aldhehyde, Diels-Alder, disulfide bonds or reversible supramolecular interactions based on electrostatic interactions, hydrogen bonding, host-guest interactions and polyrotaxane-containing polymers, but the reported findings were limited to polymer films and have not yet been extended to surface-attached transparent coating.

Nanocomposite transparent self-healing polymers have been used to improve mechanical properties by introducing nanoparticles such as: inorganic adhesive titania bonded silica, silica-fluoropolymer hybrid nanoparticles for translucent superamphiphobic, core-shell nanofiber and electrospun core-shell, nanofiller-reinforced nanofiber coating and nanoscale clay platelets but they have not yet been used to design transparent polymer coating.

Extrinsic self-healing based on microcapsules and the release of healing agent for the design of mechanically robust transparent self-healing polymers is far the most convenient strategy as the microcapsules scatter light and consequently reduce light transmittance.

The stability of the polymer coating can be improved by introducing a linker between the polymer coating and the substrate, but on the other hand, it will affect the self-healing by reducing the polymer chain mobility. Self-sealing coating based on amphiphilic polymer conetworks (APCNs) covalently attached to breathable membranes were reported for the design of breathable membranes that have the ability to close punctures. Nevertheless, they did not repair the damage permanently as they needed to remain in a swollen state.

### SUMMARY

The invention has for technical problem to provide a solution to at least one drawback of the above cited prior art.

One of the aims of the invention relates to introducing reversible supramolecular interactions based on metal complexes into MSMC that would lead to self-healing materials, preferentially transparent, that exhibit robust mechanical properties and that can be used in the medical field. One of the strategies to sustain the reliability of performance is to avoid the formation of cracks arising from the formation of undetected minor damage, which would lead to complete failure of the materials.

For this purpose, the invention is directed to metallo supramolecular polymer conetworks of poly[r(alkyl)ₐ-N-(pyridin-s-yl) (meth)-acrylamide moiety]_{m,n} derivatives-complexed to a transition metal cation-linked by poly(dimethylsiloxane)palkyl-(meth)-acrylate moiety derivatives, wherein a is 0 or 1 or 2, p is an integer selected from the group consisting of from 50 to 70 and of from 120 to 180, r is integer of from 0 to 4, and s is an integer of from 2 to 4, and m and n, independently, are integers of from 5 to 11.

The present disclosure has shown that such metallo supramolecular polymer conetworks (MSMC), that are typically tri-dimension conetworks, can advantageously be used for the preparation of films and/or coatings on various substrates, that can be used in the medical field verey advantageously providing anti-bacterial effect. Accordingly, such MSCN can be used as protective coating for optical medical devices, avoiding any bacterial proliferation, or, in some applications, for repairing damaged skin. The MSMC exhibit improved mechanical properties, such as exhibiting a Young modulus (E) of at least 100 MPa, preferentially of 100-170 MPa, better of 100-140 MPa with a tensile strength of 7-9 MPa and a strain at break of 0.25 to 0.35, measured at strain rate of 10 mm/min.

Coatings and/or films including MSMC are an interesting pathway for the design of mechanically robust coatings, preferably transparent coating and/or films. The desired functionality is achieved by tuning the chemical composition of the polymer segments, and most importantly, the covalently interconnected phase-separated domains advantageously smaller than light wavelengths, which results in optically transparent polymers and coatings. Accordingly, the design of phase-separated nanostructured polymers with the hard phase providing good mechanical properties while the soft one, equipped with the supramolecular bonds, endows the materials with the self-healing behaviour. The covalently interconnected hydrophilic chains of poly[r(alkyl)ₐ-N-(pyridin-s-yl) (meth)-acrylamide moiety]_{m,n} derivatives complexed to a transition metal cation and hydrophobic chains of poly(dimethylsiloxane)ₚalkyl-(meth)acrylate moiety derivatives of MSMC result in phase-separated morphologies. In such a case, the transition metal cation is linking two nitrogen groups of the pyridine moiety.

Where the MSMC is used in the preparation of a coating, the latter is covalently linked to a substrate to avoid delamination or etching of the coating in contact with organic solvent or in water, in contrast to previously reported self-healing coatings, which would simply delaminate.

MSMC have the ability to swell reversibly in organic solvent or in water depending on chemical composition of the polymer conetwork. This ability was used to trigger the scratch-healing property where liner polymer chains would dissolve or precipitate.

For example, MSMC can lead to protective transparent and scratch-healing coatings for optical and medical field applications. The loading of fluorescent dye in MSMC can lead to sensor with tunable signals (pH, redox, temperature, solvent etc.), and MSMC coatings, exhibiting an ability to bind and to release on demand metal ions, can be transparent anti-fouling coatings.

In the context of the invention, “(meth)-acrylate” means acrylate and/or methacrylate derivatives. The present disclosure has shown that such derivatives are necessary to obtain the desired properties.

The transition metal cation can advantageously be selected form the group consisting of zinc and manganese cations, preferentially zinc cation. These both zinc and manganese cations are the best suited metal cations because they are better strengthening the polymer network by cross-linking two nitrogen groups of the pyridine moiety while offering reversible interactions required for self-healing ability of MSMC.

In some embodiments, the alkyl group in the [r(alkyl)ₐ-N-(pyridin-s-yl) entity can be selected from the group consisting of methyl, ethyl, propyl and butyl groups, optionally substituted by other alkyl groups, or a mixture thereof. The preferred alkyl groups for polymer coatings are methyl and ethyl, while aminopyridine can be the preferred for polymer films. The alkyl groups of the poly(dimethylsiloxane)ₚalkyl-(meth)-acrylate moiety derivatives can be the same as those mentioned above. Higher carbon content alkyl groups can increase the Tg of poly(dimethylsiloxane)ₚ reducing the mobility of the polymer chains needed for self-healing properties.

The value of “r” is depending of the nature of the alkyl group linked to the pyridine-s-yl group.

More preferably, the integer “r” can be dependent on the alkyl group of (alkyl)ₐr(pyridin-s-yl) moiety.

Consequently, when the alkyl is present, “a” being 1 or 2, preferably “a” being 1, r is 1 when the alkyl group is methyl, r is 2 when the alkyl group is ethyl, r is 3 when the alkyl group is propyl and r is 4 when the alkyl group is butyl. When “a” is 0, then there is no alkyl group, then “r” is 0, for example: aminopyridine.

The integer “s” in the pyridin-s-yl group is the position of N in the pyridine ring with regard to (meth)-acrylamide moiety. Accordingly, “s” is 2, 3 or 4. It is advantageously preferred that N in the pyridine ring is at the position para or 4. This specific para position enhances the interaction of the metal cation with N of the pyridine ring (intra-chain bonds). Other positions (2 or 3) favour the intra-chain bonds between two adjacent N in the cycle, which is less preferred.

It is very preferred that the transition metal cation bears a counter ion enhancing the coordinating strength, in addition to the fact that the counter ion acts as a bridging ligand leading to fast self-healing. In other words, without being bound by any theory, the counter ion is preferably selected to allow the transition metal cation to be surrounded by less nitrogen groups of the pyridine moieties.

The counter ion can then be selected among organic or inorganic anions. The inorganic anion is advantageously chloride or nitrate, providing the best coordinating strength and self-healing ability.

According to a preferred embodiment, the “m” and “n” integer values are selected based on the final use of the MSMC. When the MSMC is a film, “m” and “n” integer values are preferably of from 5 to 7, and when the MSMC is used to prepare a coated substrate, “m” and “n” integer values are preferably from 8 to 11. Higher integer values for “m” and “n” of 8 to 11 are preferably selected to enhance the swellability of the pyridine containing phase. The m,n values, independently, are preferably integer of from 5-10, more preferably m=n.

The MSMC product could be advantageously in the form of a film, which can be transparent having a thickness of from 200 μm to 500 μm, more preferably of from 250 μm to 450 μm, even more preferably of from 250 μm to 430 μm, most preferably of from 300 μm to 400 μm.

Depending of the end use of MSMC, the polymer conetworks advantageously contains from 3 to 5 wt % of the transition metal cation, more advantageously from 3 to 4.7 wt % when used to prepare a film.

When the final use is a coating on a substrate, the polymer conetworks advantageously contains from 5 to 9 wt % of the transition metal cation, more advantageously from 6 to 8.6 wt %. These values are the preferred for the desired properties.

When the film is preferably used to be coated on a substrate, the thickness thereof is advantageously of from 4 μm to 10 μm, preferably of from 5 μm to 8 μm.

The integer p can preferentially be selected from the group consisting of ranges of from 60 to 70 and of from 130 to 170, of from 60 to 65 and of from 125 to 170, of from 60 to 65 and of from 125 to 150, of from 65 to 70 and of from 145 to 160. It appears that the best results are obtained for such p values.

The invention also relates to process of preparing the MSMC according to the invention. The process comprises the following steps of:

a) providing a reaction medium comprising a mixture of (alkyloxy)-(meth)-acrylate moiety derivatives-poly(dimethylsiloxane)ₚ type compounds wherein p is an integer selected from the group consisting of from 50 to 70 and of from 120 to 180 and an active ester comprising a pentafluorophenyl-(meth)acrylate moiety, and performing an UV-initiated polymerization using a photoinitiator, for the obtention of poly[(pentafluorophenyl-(meth)-acrylate) moiety]_{m,n} derivatives linked by poly(dimethylsiloxane)palkyl-(meth)-acrylate moiety derivatives, wherein “m”, “n” and “p” are as defined above.

b) reacting the product obtained in step a) with a r-amino(alkyl)ₐ-N-s(pyridine) for obtaining poly[r-(alkyl)ₐ-N-(pyridin-s-yl) (meth)-acrylamide moiety]_{m,n} derivatives linked by poly(dimethylsiloxane)ₚalkyl-(meth)-acrylate moiety derivatives, wherein “r”, “s” and “a” are as defined above;

c) complexation of the derivatives obtained in step b) by a transition metal cation in an organic solvent.

According to the process of the invention, it is possible to advantageously prepare a scratch-healing, preferably transparent, film or a coating on various substrates that is mechanically robust from amphiphilic polymer conetworks cross-linked by transition metal complexes and, depending on the final use, to provide coatings covalently attached onto the surface of a substrate for high resistance to delamination.

The final polymer, MSMC, is prepared in a three-step UV-initiated polymerization reaction offering the benefit of large-scale synthesis using only commercially available chemicals.

According to the process, the step a) is performed by the use of a photoinitiator. The preferred photoinitiator is selected from the group consisting of benzyldimethyl-ketals and hydroxyketones, or mixtures thereof. One example of a photoinitiator is Irgacure® 651 or those of the family of Irgacure® compounds, such as Irgacure® 184: 1-Hydroxy-cyclohexyl-phenyl-ketone and Irgacure® 2959: 2-Hydroxy-1-[4-(2-hydroxyethoxy)phenyl]-2methyl-1-propanone].

The mixture according to step a) includes an active ester of pentafluorophenyl-(meth)-acrylate moiety. The acrylate moiety is defined above. The preferred active ester is pentafluorophenyl acrylate or pentafluorophenyl methacrylate, especially pentafluorophenyl acrylate (PFPA).

The (alkyloxy)-(meth)-acrylate moiety derivatives-poly(dimethylsiloxane)ₚ type compounds, also expressed in the specification as poly(dimethylsiloxane)ₚ moieties, are preferably depending on the end use thereof, and are those preferably exhibiting viscosity of from 50 to 90 cSt (standard conditions), having a Mn of from about 4000-5000, or 125-250 cSt, having a Mn of from about 8000 to 11 000, the alkyl group and (meth)-acrylate moiety derivatives being such as defined above. An example of such derivatives is α,ω-propyloxymethacrylate-terminated poly(dimethylsiloxane)ₚ.

The UV-initiated polymerization was carried out preferably of from 2 to 5 min, preferably of from 2 to 3 min. Known devices are used for said step a). Before UV-irradiation, the mixture can be placed in a mould. The step a) can classically be performed at ambient temperature, or the mixture can be heated below the boiling temperature of the used solvent, if present, and/or of the mixture components.

Advantageously, the amount of the active ester in the mixture can be of from 45 wt % to 60 wt % allowing the preparation of the final product (MSMC) which is transparent and exhibiting enhanced optical properties. Accordingly, the amount of the poly(dimethylsiloxane)ₚ moieties in the mixture can be of from 40 wt % to 55% wt %. The mixture in the reaction medium can additionally be added, when appropriate-depending of the liquid or solid nature of the starting derivatives and compounds, in an organic solvent, preferably THF, halogenated alkanes, aromatics, ketones, or mixture thereof, amount of which can be of from 5 to 10 wt %. The weight % of the three considered reactants are based on the total weight, which can be higher than 100 wt %.

The resulting polymer of step a) are poly[(pentafluorophenyl-(meth)-acrylate moiety]_{m,n} derivatives, also referred to moiety I, linked by poly(dimethylsiloxane)ₚalkyl-(meth)acrylate moiety derivatives, also referred to moiety II.

The concentration of the photoinitiator is 0.5 wt % to 1 wt % of the total monomer mixture.

The obtained derivatives can contain from 40 wt % to 50 wt %, preferably from 42 wt % to 45 wt % of the moiety I.

The step a) can further include a washing step of the resulting polymer carried out with the solvent used for the polymerization, at temperatures typically of from 40° C. to 70°, depending of the nature of the solvent. The washing step can also be carried out for a period of time typically of from 8 to 16 h in order to remove unreacted active ester and/or poly(dimethylsiloxane)p type compounds.

The FTIR spectrum of the polymer resulting from step a) revealed the characteristic absorption bands of the active ester typically at 1783 cm⁻¹ (C═O stretch) and 1571 cm⁻¹ (the fluorinated aromatic ring stretch). The analysis by Differential Scanning Calorimetry (DSC) showed two distinct Glass Transition Temperature (Tg) at, for example, about −120° C. and 45° C. These values correspond respectively to moieties II and I.

The step b) is considered as an amidation reaction of the polymer resulting from steps a) with the r-amino(alkyl)ₐ-N-s(pyridine) compound. The obtained compounds are poly[r(alkyl)ₐ-N-(pyridin-s-yl) (meth)-acrylamide moiety]_{m,n} derivatives (moiety III) linked by poly(dimethylsiloxane)palkyl-(meth)-acrylate moiety derivatives (moiety II).

In step b), the product obtained in step a) (moieties I and II) is reacted with an r-amino(alkyl)ₐ-N-s(pyridine) compound, preferably in presence of an appropriate organic solvent, preferably THF, halogenated alkanes, aromatics, ketones. The solvent volume is chosen by the one skilled in the art to perform the reaction of both considered entities, whether at lab scale, then typically of from 10 to 200 mL, or at industrial scale.

In order to synthesize final products resulting from steps c), (MSMC), the amount range of r-amino(alkyl)ₐ-N-s(pyridine) compound in the reaction medium is advantageously of from 1.5 molar eq. to 2.6 molar eq. based on the poly[(pentafluorylphenyl-(meth)-acrylate moiety]_{m,n} derivatives linked by poly(dimethylsiloxane)ₚalkyl-(meth)-acrylate moiety derivatives molar content.

As previously mentioned, the integer “s” in the pyridin-s-yl group is the position of

N in the pyridine ring. Accordingly, “s” is 2, 3 or 4. It is advantageously preferred that N in the pyridine ring is at the position para or 4. This specific para position enhances the interaction of the metal cation with N of the pyridine ring (intra-chain bonds). Other positions favour the intra-chain bonds between two adjacent N in the cycle, which is less preferred.

The alkyl groups of the r-amino(alkyl)a-N-s(pyridine) are not limited with the proviso that the final product exhibits the desired properties, and can be selected from the group consisting of methyl, ethyl, propyl and butyl, optionally substituted by other alkyl groups, or mixture thereof. When the integer a is 0, there are no alkyl groups in the aminopyridine.

The temperature reaction of step b) is advantageously of from 40° C. to 70° C., and is in fact selected to be typically below that the boiling temperature of the reaction medium. The reaction time is typically of from 4 h to 16 h, especially from 8 h to 16 h.

The step b) can further include an incubating step in an organic solvent, preferably the same solvent as used for the step b), to remove, for example, the pentafluorophenol residue(s) from the bulk of the obtained derivatives. The incubating step can be carried from 8 h to 24 h, at temperatures of from 40° C. to 70°. At the end of the reaction or after the optional incubating step, the reaction medium can be dried. The derivatives of step b) can remain solid and stored in a desiccator, for example.

According to the FTIR spectrum analysis, the peak assigned to the active ester disappeared and was replaced by the amide stretch signal, for instance at 1685 cm⁻¹ and the pyridine ring vibration signal at 1592 cm⁻¹. Analysis by DSC confirmed the functionalization by revealing Glass Transition Temperatures (Tg) at about 70° C.-80° C., especially circa 75° C., that can be assigned to the moiety III.

The step c) is the complexation of the derivatives obtained in step b) by a transition metal cation in an organic solvent.

This latter step allows the obtention of the product of the invention, namely MSMC, which properties and characteristics are as above described.

Namely, step c) leads to poly[r(alkyl)ₐ-N-(pyridin-s-yl) (meth)-acrylamide moiety]_{m,n} derivatives-complexed to a transition metal cation-linked by poly(dimethylsiloxane)ₚalkyl-(meth)-acrylate moiety derivatives, wherein “a” is 0 or 1 or 2, “p” is an integer selected from the group consisting of from 50 to 70 and of from 120 to 180, “r” is integer of from 0 to 4, and “s” is an integer of from 2 to 4, and “m” and “n”, independently, are integers of from 5 to 11.

The transition metal cation is advantageously selected form the group consisting of zinc and manganese cations, preferentially zinc cation. These both zinc and manganese cations are the best suited metal cations because they are better strengthening the polymer network by cross-linking two nitrogen groups of the pyridine moiety while offering reversible interactions required for self-healing ability of MSMC.

It is very preferred that the transition metal cation bears a counter ion enhancing the coordinating strength, in addition to the fact that the counter ion acts as a bridging ligand leading to fast self-healing. In other words, the counter ion can advantageously be selected to allow the transition metal cation to be coordinated by less nitrogen groups of the pyridine moieties.

The counter ion can then be selected among organic or inorganic anions. The inorganic anion is advantageously chloride or nitrate or mixture thereof, providing the best coordinating strength and self-healing ability. Chloride anion is the most preferred due to high coordinating strength thereof and because it is also acting as bridging ligand. According to the invention, the transition metal cation is selected from salts of ZnCl₂, Zn(NO₃)₂, MnCl₂ and/or Mn(NO₃)₂.

The reaction medium mixture of step c) includes an organic solvent which allows the solubility of the transition metal salt, and can preferably be THF, halogenated alkanes, aromatics, ketones, ethers, alcohols or mixture thereof, concentration of which can be of from 5 to 10 wt %, and is in fact selected to be typically below the boiling temperature of the reaction medium. The reaction is performed more preferably in THF to achieve good swelling of the derivatives of step b). It should be pointed out that the step b) derivatives are insoluble in the reaction medium of step c).

The complexation reaction can be performed at temperatures of from 40° C. to 70° C. The reaction duration is typically of from 8 h to 16 h. The step c) can further include a rinsing step in an organic solvent, preferably the same solvent as used for the step c), to remove, for example, the unreacted compounds. The solvent volume is chosen by the one skilled in the art to perform the reaction of both considered entities, whether at lab scale, then typically of from 10 to 200 mL, or at industrial scale. At the end of the reaction or after the optional rinsing step, the reaction medium can be dried for a dried-state storage of the compound.

The amount of transition metal salt can be in the range of from 0.03 mol/L to 0.05 mol/L, preferably of from 0.03 mol/L to 0.045 mol/L. These transition metal cation concentrations permit the desired properties of the MSMC to be achieved.

The Atomic Force Microscopy (AFM) analysis revealed spherical interconnected moiety II domains in a moiety III complexed to a transition metal cation phase. The moiety II domains are bigger, and the hydrophilic domains appear thinner than the domains of the metal-free derivatives (of step b)). Thus, the incorporation of metal ions into the derivatives of step b) does not change the overall phase morphology, but increases the size of hydrophobic domains, while it decreases the size of the hydrophilic domains due to the cross-linking of the moiety Ill phase.

The complexation of transition metal cations by moiety III is confirmed by solid-state NMR analysis.

It should be highlighted that all selected process features and parameters are those allowing the preparation of the MSCS

The invention also relates to a film comprising the MSMC of the invention, exhibiting all properties and characteristics as above described.

The invention also concerns a material comprising a coated film onto a substrate, said film being based on the MSMC of the invention.

Various substrates can be used. These can be organic or inorganic substrates, such as glass, ceramic, metallic or polymeric substrates, known to the one skilled in the art.

A process for preparing a material including the MSMC of the invention, coated on a substrate, comprises the following of step of:

1) grafting s(trialkyloxy-silyl)alkyl(meth)-acrylate derivatives onto the substrate,

2) providing a reaction medium comprising a mixture of (alkyloxy)-(meth)-acrylate moiety derivatives-poly(dimethylsiloxane)ₚ type compounds wherein p is an integer selected from the group consisting of from 50 to 70 and of from 120 to 180, and an active ester comprising a pentafluorophenyl-(meth)-acrylate moiety and a photoinitiator, contacting said mixture with the functionalized substrate of step 1), performing an UV-initiated polymerization, for the obtention poly[(pentafluorophenyl-(meth)-acrylate moiety]_{m,n} derivatives linked by poly(dimethylsiloxane)ₚalkyl-(meth)-acrylate moiety derivatives bound to the functionalized substrate, wherein, m, n, p, are above defined;

3) reacting the poly[(pentafluorolphenyl-(meth)-acrylate moiety]_{m,n} derivatives linked by poly(dimethylsiloxane)ₚalkyl(meth)-acrylate moiety derivatives which are bound to the functionalized substrate, with an r-amino(alkyl)ₐ-N-s(pyridine) for obtaining poly[r-(alkyl)ₐ-N-(pyridin-s-yl) (meth)-acrylamide moiety]_{m,n} derivatives linked by poly(dimethylsiloxane)ₚalkyl-(meth)-acrylate moiety derivatives, bound to the functionalized substrate, wherein “r”, “s” and “a” are as defined above;

4) complexation of the derivatives obtained in step 3) which are bound to the functionalized substrate, by a transition metal cation in an organic solvent.

The process for preparing a material including the MSMC of the invention, coated on a substrate, preferably includes steps a)-c) on the process for the preparation of MSMC according to the invention which are modified due to the presence of a functionalized substrate. Nevertheless, the process features and parameters are essentially based on the synthesis of MSMC complexed with a transition metal cation, as described above.

Specifically, the process for preparing a material including the MSMC coated on a substrate comprises following characteristics.

Step 1) includes the grafting step of s(trialkyloxy-silyl)alkyl(meth)-acrylate derivatives. The (meth)-acrylate is as previously defined, and the alkyl groups are preferably selected from the group consisting of methyl, ethyl, propyl, butyl or mixtures thereof. Non limitative examples of such s-(trialkyloxy-silyl)alkyl(meth)-acrylate derivatives can be 1-(trimethoxysilyl)methylacrylate, 2-(trimethoxysilyl)ethylacrylate, 3-(trimethoxysilyl)propylacrylate, 1-(trimethoxysilyl)methylmethacrylate, 2-(trimethoxysilyl)ethylmethacrylate, 3-(trimethoxysilyl)propylmethacrylate 1-(triethoxysilyl)methylacrylate, 2-(triethoxysilyl)ethylacrylate, 3-(triethoxysilyl)propylacrylate, 1-(triethoxysilyl)methylmethacrylate, 2-(triethoxysilyl)ethylmethacrylate, 3-(triethoxysilyl)propylmethacrylate, and the like and/or a mixture thereof.

Without being bound by any theory, it is assumed that, if a glass substrate is used, the O-groups of the glass surface of the substrate are covalently attached to the silyl groups. The surface of polymer substrates can be modified by the technique of plasma while electrochemistry can be used to modify the surface of metallic substrates.

Various substrates can be used. These can be organic or inorganic substrates, such as glass, ceramic, metallic or polymeric substrates, known to the one skilled in the art. Dimensions of the substrate are not limitative and can of from 5 cm² to 10 cm², or even more when the process is performed at an industrial scale.

Step 1) is preferably conducted in a presence of an organic solvent when appropriate-depending of the liquid or solid nature of the starting derivatives, in an organic solvent, preferably THF, halogenated alkanes, aromatics, like toluene, ketones, or mixture thereof.

Concentrations of s(trialkyloxy-silyl)alkyl(meth)-acrylate derivatives of the Step 1) in the organic solvent can preferably be comprised in a range of values of from 10 vol % to 30 vol %.

The grafting step 1) can be carried out from 8 h to 16 h, at room temperature, by reacting the s(trialkyloxy-silyl)alkyl(meth)-acrylate derivatives with the substrate, preferably s(trialkyloxy-silyl)alkyl(meth)-acrylate derivatives being in a reaction medium at the concentration specified above.

After step 1) and before step 2), the process can include a washing step of the functionalized substrate with, preferably, the same solvent as for the step 1) and with an alcohol, such as ethanol or the like and dried, for example, under vacuum. Prior to step 1), the substrate can be treated, for example, for cleaning it. When a glass substrate is used, said substrate is immersed in a Piranha solution or the like.

The (alkyloxy)-(meth)acrylate moiety derivatives-poly(dimethylsiloxane)ₚ type compounds to be selected for step 2), are those preferably exhibiting viscosity 125-250 cSt and are as above defined.

It should be pointed out that steps 3) and 4) of the considered process are similar to steps b) and c) of the process for the preparation of MSMC. In the context of the invention, the grafted functionalized substrate of step 1) is not modified by further steps 2)-4).

The amount range of r-amino(alkyl)a-N-s(pyridine) compound in the reaction medium is advantageously of from 0.05 molar eq. to 0.1 molar eq. based on the poly[(pentafluorylphenyl-(meth)-acrylate moiety]_{m,n} derivatives linked by poly(dimethylsiloxane)ₚalkyl-(meth)-acrylate moiety derivatives molar content. It should be pointed out that amount range of r-amino(alkyl)a-N-s(pyridine) compound as for step b), could also be used.

The polymer conetworks obtained through step 4) advantageously contain from 5 to 9 wt % of the transition metal cation, more advantageously from 6 to 8.6 wt %, which can be obtained by immersing the coating on the substrate into 3 to 7 mM concentration of the transition metal salt, even if concentrations thereof as mentioned for step c) could also be used, but it is less preferred.

The invention also relates to the use of the MSMC of the invention or as obtainable according to the process of the invention for use as an antibacterial agent. Indeed, biofouling represents a great concern in particular for underwater optical devices (camera, diving goggles and submarine portholes) where the surface colonization from undesired organisms interferes with the transparency. For such a specific application, optical properties must remain unaltered during the lifetime of the materials, thus making underwater transparent antifouling coatings a highly attractive research field. MSMC coatings represent an ideal material as they combine optical transparency and fouling release properties according to their chemical composition. The transparency arises from the phase separated domains smaller than the wavelength of light, while their fouling release property is enhanced by their amphiphilic nature on the nanoscale. The adhesion of mucus secreted by a microorganism to wet the surface is energetically unfavourable due to the coexistence of hydrophobic and hydrophilic phases on the surface, leading to the inhibition of microorganism adhesion. In addition, the loading of metal complexes into the coating inhibits the adhesion of bacterial agent such as Escherichia coli SCC1 (E. coli) onto the surface.

The present disclosure has shown that a substrate that is coated with the compounds of the invention, do inhibit the adhesion of bacteria of said surface, with comparison to the uncoated substrate, of between 5 to 10 fold.

### DRAWINGS

Other features and advantages of the present invention will be readily understood from the following non limitative examples and drawings:

FIG. 1 is a schematic three-step synthesis of an MSMC: poly[N-(pyridine-4-yl)(methacrylamide moiety]_{m,n} derivatives, complexed to Zn(II) cations, linked by poly(dimethylsiloxane)ₚ α,ω-propylmethacrylate moiety derivatives (PNP4A-Zn(II)-I-PDMS) (“a” is 0) in accordance with various embodiment of the present disclosure.

FIG. 2 shows ATM-FTIR spectra of poly[(pentafluorylphenyl-acrylate)₆ moiety (PPFPA) linked by poly(dimethylsiloxane)₆₀ α,ω-propyl-methacrylate moiety (PDMS₆₀)-(PPFAP-I-PDMS₆₀) and of poly[N-(pyridin-4-yl) acrylamide]₆ linked by poly(dimethylsiloxane)₆₀ α,ω-propylmethacrylate (PNP4A-I-PDMS₆₀) in accordance with various embodiment of the present disclosure.

FIG. 3 shows a DSC of PPFAP-I-PDMS₆₀ and PNP4A-I-PDMS₆₀, PDMS₆₀ being noted PDMS in accordance with various embodiment of the present disclosure.

FIG. 4 represents AFM mode images of the cross-section of PPFPA-I-PDMS₆₀ (FIG. 4a) PNP4A-I-PDMS₆₀ (FIG. 4b) and (PNP4A-Zn(II)-I-PDMS₆₀) (FIG. 4c) in accordance with various embodiment of the present disclosure.

FIG. 5 shows solid state 13C NMR spectra of the PNP4A-I-PDMS₆₀ and the PNP4A-I-PDMS₆₀ complexed by ZnCl₂ in accordance with various embodiment of the present disclosure.

FIG. 6 shows an optical microscopy image of cross-section of scratched free standing polymer film of PNP4A-I-PDMS₆₀ complexed by ZnCl₂ in accordance with various embodiment of the present disclosure.

FIG. 7 depicts self-healing of scratches in PNP4A-I-PDMS₆₀ complexed by ZnCl₂. Optical microscopy images of scratched free standing polymer films (a and c) and of the same sample after 16 hours at 80° C. (b) and 120° C. (d) in accordance with various embodiment of the present disclosure.

FIG. 8 represents uniaxial tensile tests of PNP4A-I-PDMS₆₀ complexed by ZnCl₂, and PNP4A-I-PDMS₆₀ without Zn(II) (dashed lines) at a strain rate of 10 mm min⁻¹; Pristine samples, samples after scratch damage, and sample after healing of scratches at 120° C. for 16 hours in accordance with various embodiment of the present disclosure.

FIG. 9 is a schematic three-step synthesis of an MSMC on a functionalized glass substrate: poly[2-ethyl-N-(pyridin-4-yl)]acrylamide]_{m,n} complexed to Zn(II) cations-linked by poly(dimethylsiloxane)ₚ- α,ω-propylmethacrylate (PNP4EA-Zn(II))-I-PDMS) in accordance with various embodiment of the present disclosure.

FIG. 10 shows transmittance measurements of functionalized glass substrate coated with PPFAP-I-PDMS₁₃₀ (PPFAP and PDMS having the same meanings as in FIG. 1 & 2), PNP4EA-I-PDMS₁₃₀ (not complexed to Zn(II)), PNP4EA-Zn(II)-I-PDMS₁₃₀ in accordance with various embodiment of the present disclosure.

FIG. 11 are surface AFM height and phase mode images of PPFPA-I-PDMS₁₃₀ (a: height and b: phase); PNP4EA-I-PDMS₁₃₀ (c: height and d: phase) and PNP4EA-I-PDMS₁₃₀ (e: height and f: phase) loaded with ZnCl₂ polymer coatings. (Scale bar: 100 nm) in accordance with various embodiment of the present disclosure.

FIG. 12 represents volumetric degree of swelling SVol of PNP4EA-I-PDMS₁₃₀ and PNP4EA-Zn(II)-I-PDMS₁₃₀ polymer conetworks films in various organic solvents and in water. (mean values of n=3 independent measurements, error bars represent SD) in accordance with various embodiment of the present disclosure.

FIG. 13 are optical microscope images of the PNP4EA-Zn(II)-I-PDMS₁₃₀ glass-coated polymer coating of the damaged surfaces (a to d) and after self-healing (e to h) in presence of THF (e), n-hexane (f), 2-propanol (g) and DMF (h) in accordance with various embodiment of the present disclosure.

FIG. 14 represents the numbers of bacteria present in a glass substrate covered by PNP4EA-Zn(II)-I-PDMS₁₃₀ with comparison with uncoated glass in accordance with various embodiment of the present disclosure.

Properties, features and technical effects of the following examples are not limitative and could be generalized to the inventive concept of the invention.

### DETAILED DESCRIPTION

### Materials

All solvents (purity>95%) were purchased from Sigma-Aldrich. Pentafluorophenyl acrylate (purity>95%), 4-Aminopyridine, 4-(2-Aminoethyl)pyridine were purchased from TCI. α,ω-propyloxymethacrylate-terminated poly(dimethylsiloxane)₆₀ (PDMS60, viscosity of 125-250 cSt., Mn (1HNMR)=8400 or α,ω-propyloxymethacrylate-terminated poly(dimethylsiloxane)₁₀₀ of viscosity of 50-90 cSt, Mn (¹HNMR)=4200) were purchased from ABCR (Germany). Irgacure 651 (2,2-dimethoxy-1,2-diphenylethan-1-one) (99%), 3-(trimethoxysilyl)propyl methacrylate (98%) and ZnCl₂ (≥98%) were purchased from Sigma Aldrich. All reagents were used without further purification unless otherwise noted. Glass slides (76×26 mm and 1 mm thick) were purchased from Carl Roth. Reactants devoted to glass substrate with the MSMC bacterial analysis are given in the Examples.

### UV Photopolymerization

A customized UV conveyor system designed by Novachem and equipped with an UV-C Flood Lamp, fitted with Mercury bulb, with peak emission at 225 nm was used.

### Infrared (IR) Spectroscopy

Attenuated total reflectance Fourier transform infrared (ATR FT-IR) spectra were recorded on a Bruker Tensor 27 spectrometer on the surface of the polymer conetworks. Proteus software was used to collect and analyze the data.

### Atomic Force Microscopy (AFM)

AFM analysis was conducted on a scanning probe microscope MFP3D infinity (Asylum Research, Santa Barbara). Measurements were performed at ambient conditions in tapping mode with a silicon AFM probe AC160TS-R3 (Olympus, Japan) with a force constant of 26 N m−1 and resonance frequency of 300 kHz. Topography was acquired by maintaining the amplitude at the first cantilever resonance constant via the electronic feedback loops. All the nanomechanical measurements of the coating were performed in fast force mapping with 30 nN force setpoint, enabling the recording of topography and a force-curve at each pixels of the 256 pixels×256 pixels images. These measurements were performed using a AC240TS tip (2.4 N/m (Olympus). Tips spring constant and inverse optical lever sensitivities were obtained with the Sadler non-contact. The polystyrene/low density polyethylene (PS/LDPE) (Bruker, Santa Barbara) copolymer was used as the reference, while the LDPE domains were used to calibrate the AFM tip and for the fitting of the force curves. The viscoelastic properties of the surface were determined according to Oliver-Pharr model. The recorded data were fitted according to the parameters determined from the LDPE analysis, and elastic modulus were extracted from of the entire scanned surface.

### Optical Microscopy

The microscopy images were recorded on Nikon Eclipse LV 100 (3×2 Stage Japan) equipped with LU Plan Fluor objectives. 5×/0.15 A WD 18 and 10×/0.30 A WD15 were mainly used. The surfaces of APCNs films were captured using NIS Elements BR 2.30 software with a resolution of 800×600 pixels.

### ICP-MS

The polymer samples were mineralized in microwave oven (Multiwave Pro, Anton Paar, Graz, Austria). 7 mL of nitric acid (HNO₃ for trace analysis min 67%, LGC Standards, Molsheim, France) and 3 mL of H₂O₂ (30% w/w, Suprapur, Merck, VWR International, Leuven, Belgium) were added to 10 mg of the samples and mineralization was performed at 200° C. under high pressure of 30 bars. At the end of the mineralization process, samples were diluted up to 25 mL of ultra-pure water. The samples were then diluted and zinc was analyzed by Inductively Coupled Plasma Mass Spectrometry (ICP-MS 7900, Agilent Technologies, Santa Clara, Calif., United States).

### Swelling Measurements

Dry samples of 0.5-2 cm² were immersed into THF, hexane, water or DMF overnight. The edge lengths Lᵢ before and after swelling were measured with a ruler and the average volumetric degree of swelling Sᵥₒₗ was subsequently determined from the sample edges (length L) as with n denoting the number of edges.

$$Svol = \frac{1}{n} {{\sum }_{i = 1}}^{n} ( \frac{Li , swollen}{Li , dry} )$$

### UV-Vis Analysis

The transmittance of the glass-coated polymer conetwork was measured on Perkin Elmer Lambda 35 UV-visible spectroscopy.

### Differential Scanning Calorimetry (DSC)

DSC traces were recorded on a NETZSCH DSC 240 F1. A heating rate of 20 K min⁻¹ was set from −170° C. to 200° C. as the temperature range under nitrogen flow. The data was collected and analyzed by NETZSCH Proteus Thermal Analysis software. The glass transition temperatures were determined on the mid-point of the transition for the second heating cycle.

### Tensile Tests

Mechanical tests were performed on Instron (59-67) tensile test machine. The samples were cut into rectangular strips of 5×1 cm2 and gripped using pneumatic clamps. Tests were performed with a strain rate of 10 mm min−1. The Young's moduli for MSMC films were calculated from the slope of the initial linear region of stress-stain curves. Each measurement was repeated at least three times. Mean values and standard deviation are reported.

### Elemental Analysis

Elemental analysis of the polymer conetworks films were performed at Mikroanalytisches Labor Pascher Germany. Different methods were used to measure the content of each element: conductometric detection after combustion was used for carbon; IR-detection after combustion was used for hydrogen; volumetric detection after combustion (according to Dumas) was used for nitrogen and detection by ion-sensitive electrode after Schöniger combustion was used for fluorine.

### Bacterial Adhesion Test

The surfaces comprising MSMC were pre-sterilized by autoclaving at 105° C., a process validated by a preliminary test. Each surface was glued in a 35 mm petri dish with an adhesive (Aqua Silicone, Den Braven, Netherlands) to prevent flotation of the sample.

### Preparation of the Bacterial Suspension

The study was carried out with the strain Escherichia coli SCC1 (E. coli), the culture medium chosen for the study is a non-nutritive medium NaCl (9 g/L). The bacteria stored in the freezer at −80° C. were cultured on D-2 (2 days before experiments) on Luria Broth (LB) agar for obtaining colonies. On D-1 a solution of nutrient medium LB was inoculated with a colony of E. coli. coli and incubated at 30° C., 15 h-20 h.

On D-0 (the day of the experiment), a new bacterial culture was prepared with 10%-15% of the preculture and incubated for 3 h-5 h at 30° C. This culture was centrifuged at 3500 rpm for 20 min, the pellet of bacteria was resuspended in NaCl (9 g/L) to obtain an OD (optical density) at 600 nm of 0.01.

The surfaces were incubated in 3-5 mL of the bacterial solution prepared according to the previous protocol for 1 hour at 30° C. and then rinsed 5-10 times in NaCl at 9 g/l before being observed under the LSM800 (Zeiss) right confocal microscope.

On each surface 10 random areas were imaged and analyzed using FiJi image processing and analysis software. In each of these areas the number of bacteria was determined.

### Example 1: Step a): Synthesis of Derivatives of poly[(pentafluorylphenyl)acrylate]₆ Moiety (PPFPA) Linked by poly(dimethylsiloxane)₆₀ α,ω-propylmethacrylate moiety (PDMS)₆₀-(PPFPA-I-PDMS₆₀)

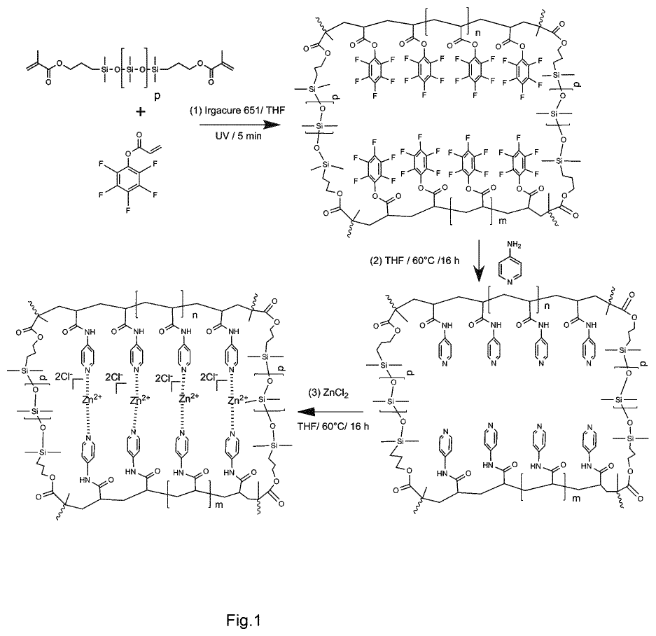

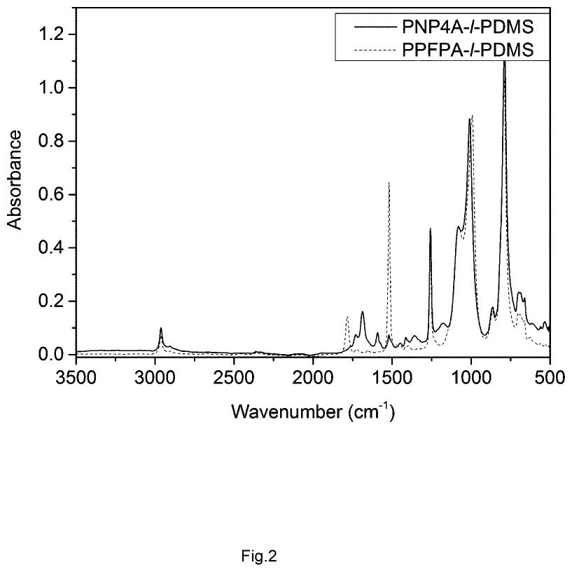

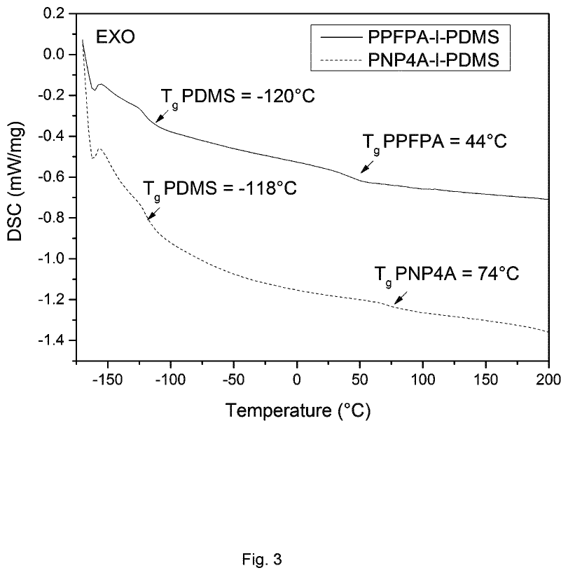

The PPFPA-I-PDMS60 conetwork precursors were synthesized by UV-initiated polymerization in the presence of Irgacure 651 (2,2-dimethoxy-1,2-diphenylethan-1-one. A reaction medium, comprising a mixture containing 51 wt % of pentafluorophenyl acrylate (PFPA) and 48.5 wt % of α,ω-propyloxymethacrylate-terminated poly(dimethylsiloxane)₆₀, was prepared, and further diluted with 10 wt % of THF into which the initiator Irgacure 651 had been dissolved at 0.5 wt % (FIG. 1). A U-shaped 500 μm thick Teflon membrane was tighten between two glass slides covered with a brown polypropylene (PP) tape, forming a mould (not shown). The monomer mixture was filled into the mould and irradiated with UV light during 2.5 min. The resulting freestanding and optically transparent film of ca. 430 μm thick, 7 cm length, and 1.7 cm width, was transferred into a screw cap bottle and washed in THF at 60° C. overnight in order to remove unreacted PFPA and PDMS cross-linker. The content of PPFPA in the polymer was 43 wt % PPFPA as measured by elemental analysis. The FTIR spectrum of the polymer conetwork precursor revealed the characteristic absorption bands of the active ester at 1783 cm⁻¹ (C═O stretch) and 1571 cm⁻¹ (the fluorinated aromatic ring stretch) as shown in FIG. 2. DSC analysis of the precursor conetwork revealed two distinct glass transition temperatures at ca. −120° C. and 44° C. They correspond to the PDMS₆₀ and active ester phases, respectively (FIG. 3). FT-IR measurements: u=2963, 1783, 1665, 1571, 1471, 1451, 1393, 1260, 1078, 990, 860, 795, 702, 623 (cm⁻¹).

### Example 2: Step b): Synthesis of poly[N-(pyridin-4-yl)acrylamide]₆ (Moiety III), Linked to poly(dimethylsiloxane)₆₀ α,ω-propylmethacrylate (Moiety II) (PNP4A-I-PDMS₆₀)

4-Aminopyridine (0.176 g-1,868 mmol) was dissolved in 50 mL of THF and the solution was transferred into a screw cap bottle (250 mL). A PPFPA-I-PDMS₆₀ film (0.416 g-0.747 mmol of PPFPA) was immersed in the solution, and the bottle was placed overnight into glycerol bath heated at 60° C. to yield poly[(N-(pyridin-4-yl)acrylamide)]6-l-poly(dimethylsiloxane)₆₀ methacrylate (PNP4A-I-PDMS₆₀).

According to the FTIR spectrum analysis, the peak assigned to the active ester disappeared and was replaced by the amide stretch signal at 1685 cm⁻¹ and the pyridine ring vibration signal at 1592 cm⁻¹ (FIG. 2). DSC analysis confirmed the functionalization by revealing a new Tg at 74° C. that can be assigned to the PNP4A phase (FIG. 3). Elemental analysis of nitrogen allowed to determine the concentration of PNP4A corresponding to 18.5 wt % corresponding to ca. 70% of the yield considering the determined content of the activated ester precursor. The higher glass transition temperature of PNP4A arises from stronger π-π interactions inherent to N-heterocyclic aromatic rings. It is worth noting that the Tg of the PDMS₆₀ phase remained almost unchanged (ca. −118° C.).

The swelling ability of the polymer conetwork was tested in various organic solvents and water. One of the outstanding features is their ability to swell both in organic solvents and in water, which can be tuned by the composition of the polymer conetwork and its chemical functionality.

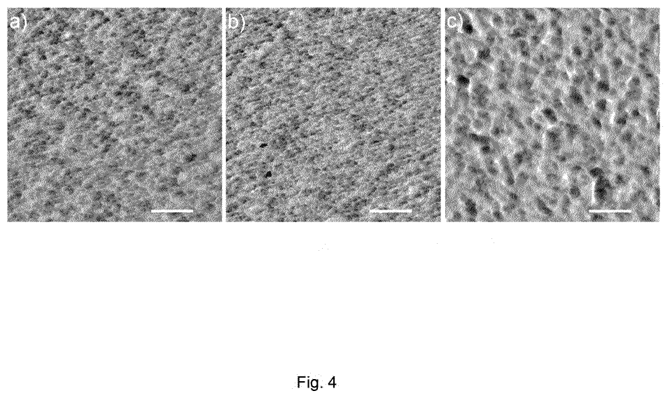

The polymer conetwork films were immersed in THF, a good solvent of the PNP4A and PDMS₆₀ phases. An average volumetric degree of swelling (SVol) of 2.14±0.14 revealed a good swelling ability of the polymer conetwork in THF (FIG. 4). Immersing the film in n-hexane, a selective solvent of PDMS₆₀, resulted in lower swelling (Svol=1.48±0.10), because the PNP4A phase did not swell. A slightly lower swelling ability of Svol=1.42±0.06 was determined in DMF, a selective solvent of the PNP4A phase. In contrast, when the films were immersed in water, they revealed a poor swelling ability with only a Svol of 1.07±0.10. Most likely, hydrophobic interactions between N-heterocyclic aromatic groups hindered the swelling of the polyacrylamide phase in water. The phase morphologies of the polymer conetworks was analyzed by AFM phase mode imaging. A contrast between hard and soft phases arising from their difference in energy dissipation is expected. The bulk morphology of the PPFPA-I-PDMS₆₀ conetworks revealed phase-separated morphologies with interconnected spherical PDMS₆₀ domains (ca. 10 nm in diameter) that are homogenously dispersed in the PPFPA matrix. The PNP4A-I-PDMS₆₀ conetworks exhibited roundish PDMS60 domains similar to the morphology of the active ester-based conetworks. In addition, the phase morphologies were imaged on the surface of the synthesized polymer showing similar morphologies to bulk (FIG. 4b).

FT-IR: u=2962, 1732, 1685, 1592, 1521, 1450, 1412, 1355, 1258, 1169, 1083, 1064, 1011, 863, 792, 687, 661 (cm⁻¹) Elemental analysis (unit: mass-%) of PNP4A-I-PDMS C 41.3, H 7.4, N 3.5

Example 3: Step c): Synthesis of MSMC: poly[N-(pyridine-4-yl)] acrylamide]₆ Complexed to Zn(II) Cation)] Linked by poly(dimethylsiloxane)₆₀-α,ω propylmethacrylate (PNP4A-Zn(Il)-I-PDMS₆₀)

A PNP4A-I-PDMS60 polymer conetwork film (5×1 cm²) was immersed in 30 mL of THF into which ZnCl₂ had been previously dissolved concentration of which is 0.038 M/L ZnCl₂. The solution was heated to 60° C. overnight. The film was then rinsed in THF, and dried overnight under vacuum. The concentration of Zn(II) in the material was determined by Inductively Coupled Plasma Mass Spectrometry (ICP-MS) analysis to be 4.5±0.1 wt. %. This content corresponds to a molar ratio of PNP4A to Zn(II) close to 2:1. AFM revealed spherical interconnected PDMS₆₀ domains in a PNP4A-Zn(II) phase (FIG. 4c). The PDMS₆₀ domains are bigger, and the hydrophilic domains appear thinner than the domains of the metal-free APCN. Thus, the incorporation of metal ions does not change the overall phase morphology of (PNP4A-Zn(II)-I-PDMS₆₀, but increases the size of hydrophobic domains, while it decreases the size of the hydrophilic domains due to the cross-linking of the PNP4A phase.

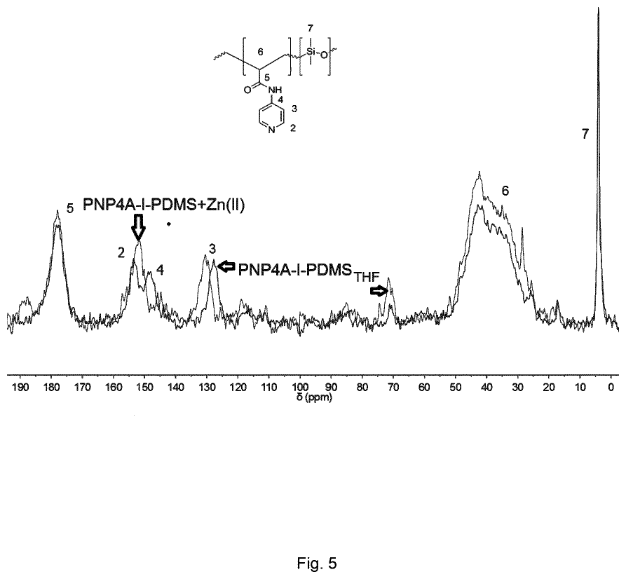

The complexation of Zn(II) ions by poly(N-(pyridin-4-yl)acrylamide) ligands was confirmed by solid-state NMR analysis. As shown in FIG. 5, the characteristic peaks of pyridine were shifted at 154 ppm CH(2), 148 ppm CH(4) and 128 ppm CH(3) for the PNP4A-I-PDMS₆₀ conetwork, while for the polymer conetwork loaded with Zn(II) only two signals shifted at 152 CH (2 and 4) ppm and 130 ppm CH(3) were observed. As the pyridine carbon signals are the most impacted by the coordination bond between the aromatic nitrogen and Zn(II), one my conclude that Zn(II) ions are complexed solely by poly(N-(pyridin-4-yl)acrylamide) ligands. FT-IR: u=2962, 1732, 1684, 1615, 1521, 1450, 1412, 1355, 1258, 1169, 1083, 1064, 1011, 863, 792, 687, 661 (cm⁻¹).

### Example 4: Self-Healing Properties of MSMC Compound of Example 3

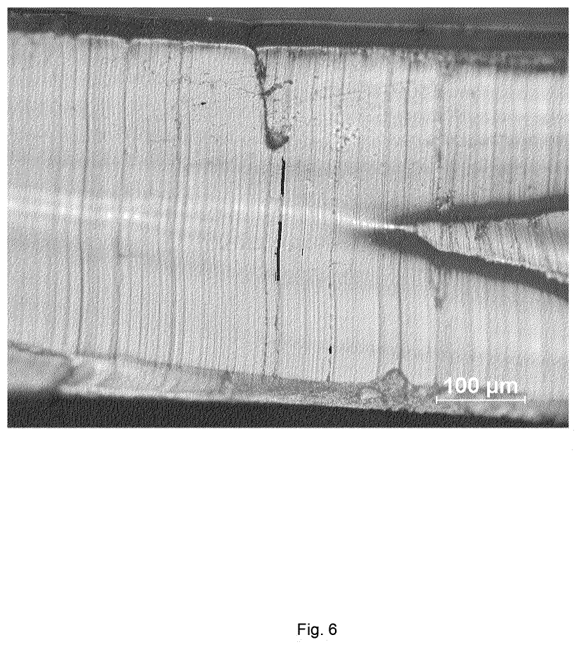

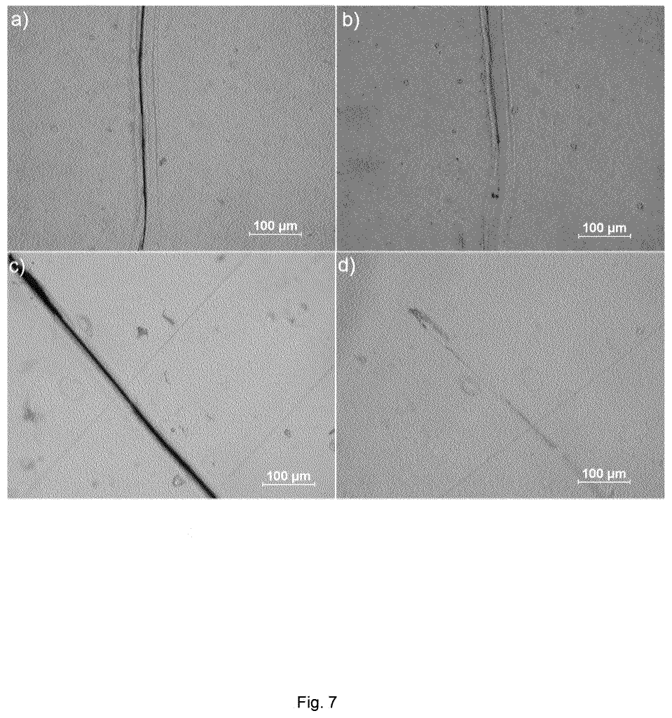

To demonstrate the self-healing ability of the MSMC of Example 3, the surface of sample was scratched using a scalpel leading to 10±3 μm scratch width and approximately 100 μm deep, representing approximately 25% of the polymer film thickness (FIG. 6). Then, the sample was placed in an oven and heated to 80° C. for 16 hours. Healing of the scratch was monitored by optical microscopy (FIG. 7). Under these conditions, the scratch closed but did not heal completely. However, when the temperature was increased to 120° C., the healing effect improved. The entire scratch healed, even though one could still observe a scar at the scratched area.

### Example 5: Self-Healing Properties of MSMC Compound of Example 3 with Regard to Mechanical Properties

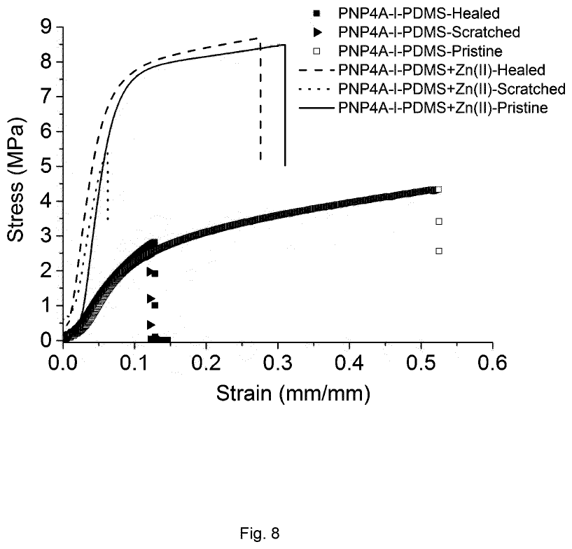

Another possibility to assess the self-healing of materials is to measure the recovery of their mechanical properties after damage and healing. To this end, tensile tests of polymer films were carried out (FIG. 8). A Young Modulus (E′) of 132±30 MPa with a tensile strength of 7.4±1.3 MPa and a strain at break of 0.31±0.04 were measured at a strain rate of 10 mm min−1 for PNP4A-I-PDMS₆₀ loaded/complexed with ZnCl₂. For comparison, the PNP4A-I-PDMS without Zn(II) exhibited a lower E′ of 25±5 MPa and a higher strain at break of 0.5, but a lower tensile strength (4.5±0.5 MPa). Thus, non-covalent cross-linking of the polymer conetwork by Zn(II) made it stiffer and strengthened it. Applying a scratch along the entire width of the strip and oriented perpendicular to the uniaxial deformation on the surface of PNP4A-I-PDMS₆₀ films loaded with ZnCl₂ reduced their mechanical properties. Polymer films broke into two parts at strain of only 0.07±0.02 (FIG. 8). Heating of scratched samples to 120° C. for 16 hours led to a strain at break of 0.25±0.03 i.e., self-heling of the scratches resulted in 80±8% recovery of strain at break. It should be noted that the polymers are covalently cross-linked in addition to the non-covalent crosslinks by the Zn(II) complexes. To demonstrate that the healing of the scratches is due to the reformation of non-covalent supramolecular crosslinks, scratches were applied on the surface of the polymer conetwork PNP4A-I-PDMS60 films that do not contain Zn(II). Tensile tests analysis revealed that heating the damaged sample at 120° C. for 16 hours did not improve the strain unlike the film loaded with Zn(II) as shown in FIG. 8 (dotted lines).

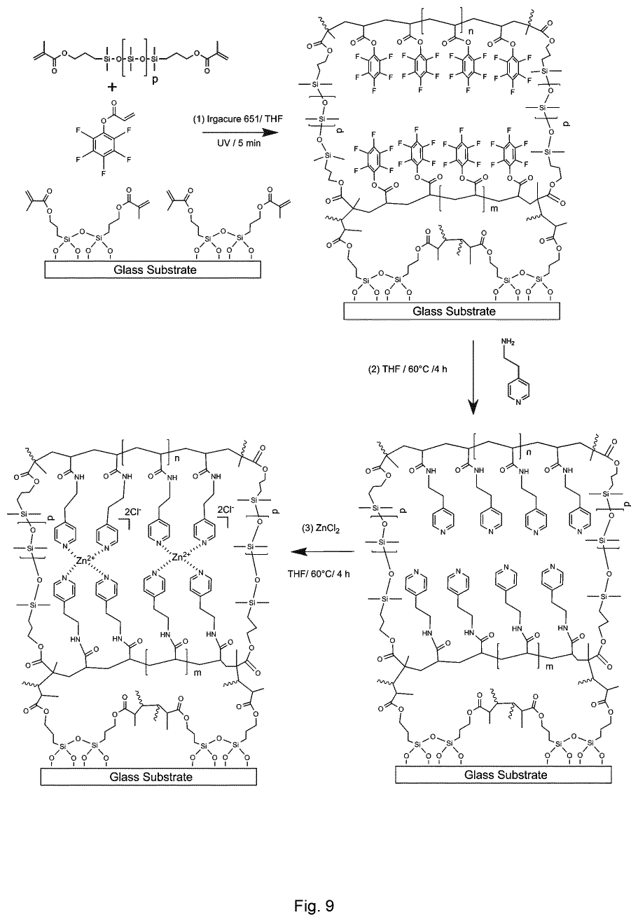

Additional examples relate the synthesis of PNP4EA-I-PDMS polymer conetworks loaded with ZnCl₂ grafted of a glass substrate, in reference to FIG. 9. The steps of preparing the MSMC of the invention grafted on said substrate essentially include same steps as of examples 1-3.

### Example 6: Steps 1-2)): Synthesis of Derivatives of poly[(pentafluorophenyl)acrylate]₁₀ Moiety Linked by poly(dimethylsiloxane)₁₃₀ α,ω-propylmethacrylate Moiety (PPFPA-I-PDMS₁₃₀)

Glass slides (2.6×3 cm²) were immersed into Piranha solution (concentrated H₂SO₄/30% H₂O₂, 3:2, v:v) for 30 min, rinsed with water and ethanol, and dried in the oven at 55° C. for 15 min. The glass slides were then transferred in 5 mL solution of dry toluene containing 20 vol % concentration of 3-(trimethoxysilyl)propylmethacrylate. The reaction took place in a tightly closed screw cap bottle for 16 hours at room temperature. The glass slide was washed with toluene and ethanol and dried under vacuum.

The preparation of the glass-coated polymer consisted in preparing a mixture containing 55% wt of pentafluorophenyl acrylate (PFPA) and 45 wt % of α,ω-propyloxymethacrylate-terminated poly(dimethylsiloxane)₁₃₀, further diluted with 10 wt % of THF into which the initiator Irgacure 651 had been dissolved at 0.5 wt %. 100 μL of the solution was casted onto the functionalized glass substrate. A glass slide covered with a PP TESA tape was placed on top of the monomer solution and tightly sealed using the binder clips (not shown). The coating was irradiated under UV light for 2.5 min from each side of the glass slide. After removing the top slide, the coated glass slide was placed in THF overnight at room temperature to extract unreacted monomers. ATR-FTIR: u=2963, 1785, 1519, 1259, 1078, 993, 863, 788, 702 (cm⁻¹).

### Example 7: Step 3): Synthesis of Derivatives of poly[2-ethyl-N-(pyridin-4-yl)]acrylamide]₁₀ Linked by poly(dimethylsiloxane)₁₃₀-α,ω propylmethacrylate (PNP4EA-I-PDMS₁₃₀) Covalently Attached to a Glass Substrate

The PPFPA-I-PDMS130 coating covalently attached onto the glass slide (2.6×3 cm²) was immersed in 10 mL of THF containing 4-(2-ethylamino)pyridine (0.010 g, 0.082 mmol). The screw cap bottle (50 mL) was placed in an oven heated at 60° C. for 4 hours. After the reaction, the coating was transferred into THF and heated at 60° C. for 2 hours to extract the residue of pentafluorophenol. The coating was then dried under vacuum before analysis. ATR-FTIR: u=3260, 3049, 2962, 1658, 1604, 1556, 1443, 1416, 1400, 1084, 1005, 865, 788, 701 (cm⁻¹).

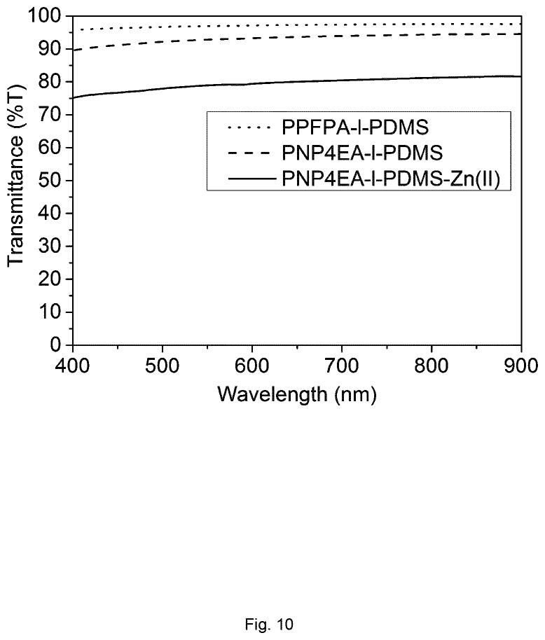

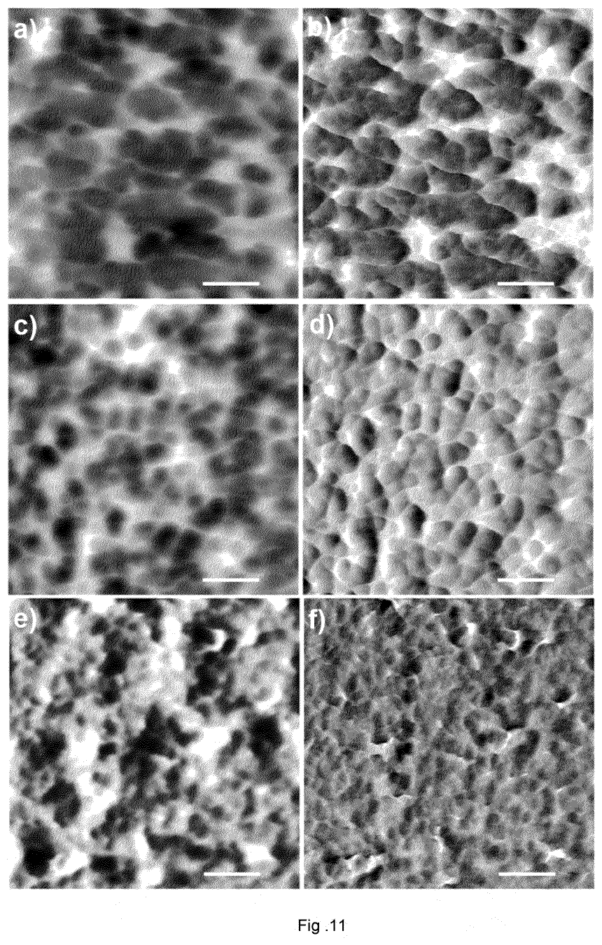

According to the FTIR spectrum analysis, the peak assigned to the active ester disappeared after the reaction and was replaced by the amide stretch signal at 1658 cm⁻¹ and the pyridine ring vibration signal at 1604 cm⁻¹ (FIG. 10). The transmittance of the polymer coating following the functionalization of pyridine ligand was measured and reached 90% (FIG. 2), indicating that the nanostructured morphologies remained unaltered, that was confirmed by AFM analysis (FIG. 11). The expected contrast between hard and soft phases, arising from their difference in energy dissipation, was evidenced. The bulk morphology of the PPFPA-I-PDMS₁₃₀ conetworks revealed phase-separated morphologies with interconnected spherical PDMS₁₃₀ domains (ca. 25 nm in diameter) that are homogenously dispersed in the PPFPA matrix (FIG. 11 a-b). The PNP4EA-I-PDMS conetworks exhibited roundish PDMS₁₃₀ domains of 28 nm±2 nm in diameter with the same morphology of the active ester-based conetworks (FIG. 11 c-d). To determine the thickness of the polymer coating, the surface of the coating was scratched using a scalpel, and the scratched area was analysed by AFM, with a thickness of approximately 5 μm.

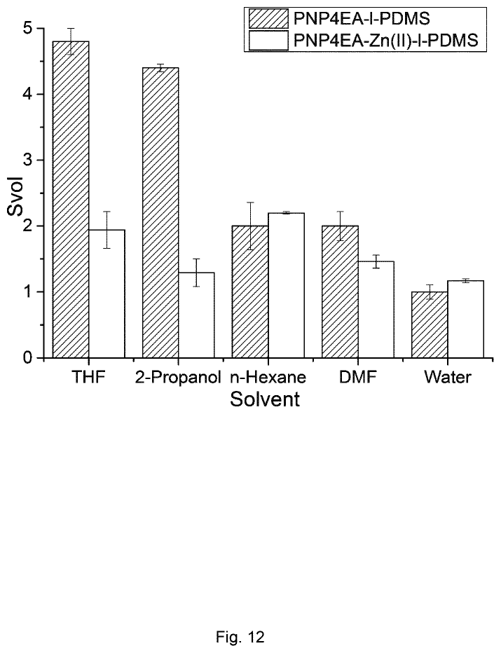

The PNP4EA-I-PDMS₁₃₀ polymer conetworks films were immersed in THF, a good solvent of the PNP4EA and PDMS₁₃₀ phases. An average volumetric degree of swelling (SVol) of 4.84±0.24 revealed a good swelling ability of the polymer conetwork in THF (FIG. 12). The films were immersed in 2-propanol, a selective solvent of PNP4EA phase with an average volumetric degree swelling of 4.4±0.06, in the same range as the one measured in THF. Immersing the film in n-hexane, a selective solvent of PDMS, resulted in much lower swelling (Svol=2.01±0.36), because the PNP4EA phase did not swell. Similarly, a lower swelling ability of Svol=2.03±0.21 was determined in dimethylformamide (DMF), a selective solvent of the PNP4EA phase. In contrast, when the films were immersed in water, they revealed a poor swelling ability with an Svol of only 1.03±0.11. Most likely, hydrophobic interactions between N-heterocyclic aromatic groups hindered the swelling of the polyacrylamide phase in water.

### Example 8: Step 4): Complexation of Derivatives of Example 7 by ZnCl₂: Obtention of PNP4EA-ZnCl₂-I-PDMS₁₃₀ Bound to the Functionalized Glass Substrate

The glass coated polymer (2.6×3 cm² and 5 μm thick) conetwork of Example 7 was immersed in THF (10 mL) containing 0.5 10⁻³ g/mL of ZnCl₂, and the solution was heated at 60° C. for 4 hours. The film was then rinsed in THF, and dried under vacuum overnight. The concentration of Zn(II) corresponding to 8.5±0.1 wt % was determined by Inductively Coupled Plasma Mass Spectrometry (ICP-MS) by detaching the coating from the glass slide. The loading of metal complexes resulted in a slight decrease of transmittance from 90 to 80% in the visible range, and was assigned to the absorption of the PNP4EA-Zn(II) complexes embedded in the bulk of the coating (FIG. 10). AFM surface analysis revealed spherical interconnected PDMS130 domains in a PNP4EA-Zn(II) phase (FIG. 11 e-f). The PDMS₁₃₀ domains are smaller, and the hydrophilic domains appear larger than the domains without Zn(II). Thus, the complexation of compound of Example 7 by Zn(II) into the PNP4EA-ZnCl₂-I-PDMS₁₃₀ decreased the size of hydrophobic domains (ca. 15 nm in diameter) due to the cross-linking of the PNP4EA phases by Zn(II).

The loading of ZnCl₂ into the polymer conetwork film (Example 7) reduced the swelling ability of the polymer conetwork due to the cross-links formed by the metal complexes within the PNP4EA phase. The average volumetric degree of swelling decreased down to 1.94±0.28 and 1.29±0.21 for THF and 2-propanol, respectively. The difference in swelling was assigned to a higher solubility of PDMS130 in THF than 2-propanol. When the polymer conetwork film was immersed in n-hexane, the swelling ability of the film was not affected (SVol=2.20±0.01) because n-hexane does not expand the PNP4EA phase in which the PNP4EA-Zn(II) complexes are localized. In DMF, the SVol of 1.46±0.1 was determined. The slight decrease of the swelling property compared to THF and 2-propanol arises from the fact that DMF is a selective solvent for the PNP4EA phase and a good ligand for metal ions. Therefore, loading Zn(II) ions slightly reduced the swelling property. In water, no improvement in the swelling ability was observed since the interactions between N-heterocyclic aromatic groups prevail over ionic interactions in water.

### Example 9: Scratch-Healing Properties of PNP4EA-ZnCl₂-I-PDMS₁₃₀ Covalently Attached to the Glass Substrate

The impact of the zinc cation on the surface property of the coating was assessed by AFM analysis. The loading of zinc cations into the polymer conetwork coating of Example 7 strengthened the network and thus improved the overall mechanical property of the coating. To highlight this effect, AFM analysis was performed using the friction force microscope (FFM) to determine the lateral forces that are acting between the AFM tip and the surface to be analyzed. The elastic modulus of the PNP4EA-I-PDMS130 surface was determined according to the Oliver-Pharr model and by using a copolymer based on polystyrene and low-density polyethylene (LDPE) as the reference for the calibration. The elastic modulus of the surface of the polymer coating was estimated at 14.01±0.6 MPa and the loading of Zn(II) ions strengthened the polymer conetwork by improving the elastic modulus to 26.27±2.00 MPa.

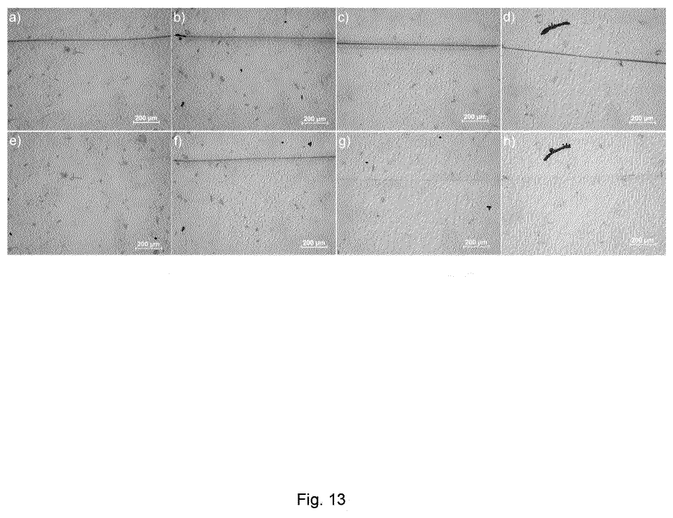

The scratch-healing property of the synthesized glass-coated polymers was tested on a polymer conetwork of PNP4EA-Zn(II)-I-PDMS₁₃₀. The surface of the sample was scratched using a scalpel to form a 15 μm scratch width, and the scratch-healing property was verified by the optical microscope (FIG. 13 a-d). The extent of the scratch healing was tested by placing the scratched polymer coating in an oven heated to 80° C. No healing effect was observed at 80° C. even after 24 hours, due to the densely cross-linked polymer network that inhibited the mobility of the polymer chains needed for the healing ability. Therefore, the swelling property of the MSMC in organic solvent was exploited to improve the self-healing property. THF was tested as a non-selective solvent of the two phases, by dropping the solvent onto the scratched surface of the coating. The glass-coated polymer was then placed in an oven heated to 65° C. for two hours. Optical microscope images evidenced the healing effect, even though one could still observe a scar on the scratched area. (FIG. 13-e). On the other hand, no healing was observed for n-hexane solvent due to the collapse of the PNP4EA phase, which inhibited the healing property of the scratch. (FIG. 13-f) Therefore a selective solvent is used in the PNP4EA phases in order to improve the swelling of the supramolecularly cross-linked phases. 2-propanol and DMF, which are the selective solvents for the PNP4EA phases, were tested. To this end, 2-propanol was dropped on to the damaged surface before the coating was placed in an oven heated to 80° C. and optical microscopy images evidenced the healing of the scratch (FIG. 13-g). DMF was also tested and because of its higher boiling point, the healing temperature was set to 150° C. to avoid any remaining solvent in the polymer film after healing. Optical images confirmed the successful scratch-healing of the coating induced by the swelling effect of DMF. (FIG. 13-h) Despite the lower volumetric degree of swelling of the overall polymer conetwork film in DMF and 2-propanol measured at room temperature, the ability to selectively swell the PNP4EA phase at higher temperature enables the healing effect.

According to the invention transparent scratch-healing coating from metallo-supramolecular polymer conetworks is successfully prepared. The combination of their swelling property in organic solvent with the reversible interactions of metal complexes offers a self-healing coating with a robust mechanical property. These materials could be used for a protective coating, taking into account that the metal complexes embedded in the polymer matrix (MSMC) can widen the scope of the application towards conductive coatings, catalytic active surfaces or even for antifouling surfaces via the release of metal ions.

### Example 10: Bacterial Anti-Adhesion Behavior of Compound Obtained in Example 3: PNP4A-ZnCl₂-I-PDMS₆₀ Bound to the Functionalized Glass Substrate

The functionalized glass substrate with PNP4A-ZnCl₂-I-PDMS₆₀ (which was prepared using the protocol of Examples 1-3 with 50 wt % of PFPA and 50 wt % PDMS₆₀) of was sterilized in an autoclave at about 105°, which was validated by a preliminary test.

Each glass surface which was glued in a Petri dish of 35 mm owing to a glue (Aqua Silicone; Den Braven, The Netherlands.

Experiments were carried out with Escherichia coli SCC1 (E.coli) in a culture medium containing NaCl (9 g/L). Frozen Bacteria (−80° C.) were cultured at D-2 (2 days before experiments) on agar Luria Broth (LB) for obtaining bacteria colonies. At D-1, a solution of a LB nutrient medium was inoculated by a E. Coli colony and further incubated at 30° C. during 18 h. At D-0, a new bacteria culture was prepared with 10% of the pre-culture and incubated 4 h at 30° C. This culture was centrifuged at 3500 rpm during 20 min, the bacteria sediment was suspended in NaCl (9 g/L) to obtain an optical density (OD) of 0.01 at 600 nm.

Glass surfaces with PNP4A-ZnCl₂-I-PDMS₆₀ were incubated in 4 mL of the bacteria solution as previously prepared during 1 h at 30° C., then washed 8 times in NaCl (9 g/L) before microscope analysis with straight confocal microscope (LSM800- Zeiss). On each surface, 10 random areas were imaged and analyzed with a FiJi software for image treatment. On each area, the number of bacteria was determined.

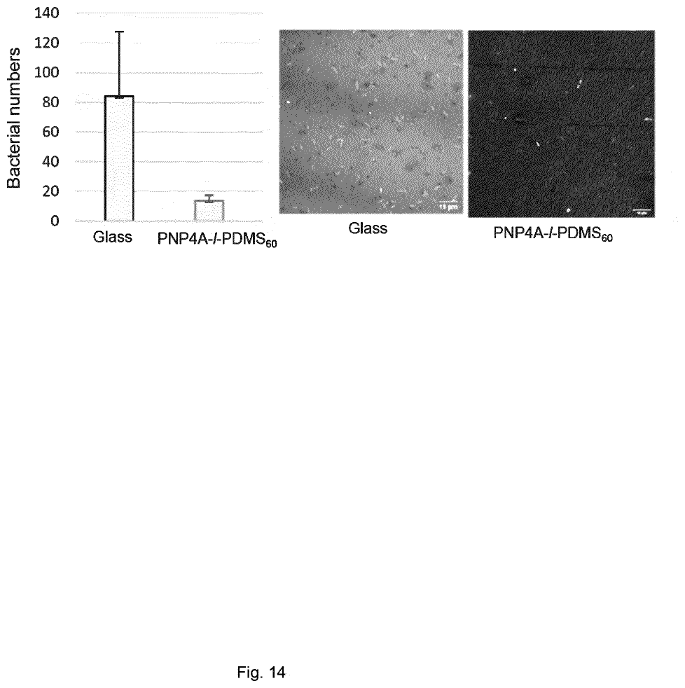

Results are depicted in FIG. 14. The results show that the coated glass inhibits the proliferation of bacteria of the coated surface.

1.-20. (canceled)

21. A metallo supramolecular polymer conetworks (MSMC) of poly[r(alkyl)ₐ-N-(pyridin-s-yl) (meth)-acrylamide moiety]_{m,n} derivatives complexed to a transition metal cation-linked by poly(dimethylsiloxane)ₚalkyl-(meth)-acrylate moiety derivatives, wherein a is 0 or 1 or 2, p is an integer selected from the group consisting of from 50 to 70 and of from 120 to 180, r is integer of from 0 to 4, and s is an integer of from 2 to 4, and m and n, independently, are integers of from 5 to 11.

22. The metallo supramolecular polymer conetworks according to claim 21, wherein the (meth)-acrylate moiety derivatives are at least one of acrylate and methacrylate derivatives.

23. The metallo supramolecular polymer conetworks according to claim 21, wherein the transition metal cation is selected form the group consisting of Zinc and Mn cations.

24. The metallo supramolecular polymer conetworks according claim 21, wherein the alkyl groups are at least one selected from the group consisting of methyl, ethyl, propyl and butyl, or mixture thereof.

25. The metallo supramolecular polymer conetworks according to claim 21, wherein the inorganic anion is chloride or nitrate thereof

26. The metallo supramolecular polymer conetworks according claim 21, wherein p is selected from the group consisting of from 60 to 70 and of from 130 to 170, of from 65 to 70 and of from 145 to 160.

27. The metallo supramolecular polymer conetworks according to claim 21, wherein s is 4.

28. A method of preparing a metallo supramolecular polymer conetworks (MSMC) of poly[r(alkyl)ₐ-N-(pyridin-s-yl) (meth)-acrylamide moiety]_{m,n} derivatives complexed to a transition metal cation-linked by poly(dimethylsiloxane)ₚalkyl-(meth)-acrylate moiety derivatives, wherein a is 0 or 1 or 2, p is an integer selected from the group consisting of from 50 to 70 and of from 120 to 180, r is integer of from 0 to 4, and s is an integer of from 2 to 4, and m and n, independently, are integers of from 5 to 11, comprising the following steps of:
providing a reaction medium comprising a mixture of (alkyloxy)-(meth)-acrylate moiety derivatives-poly(dimethylsiloxane)ₚ type compounds wherein p is an integer selected from the group consisting of from 50 to 70 and of from 120 to 180 and an active ester of pentafluorophenyl-(meth)acrylate moiety, and performing an UV-initiated polymerization using a photoinitiator, for the obtention of poly[(pentafluorophenyl-(meth)-acrylate moiety]_{m,n} derivatives linked by poly(dimethylsiloxane)ₚalkyl-(meth)-acrylate moiety derivatives;
reacting the product obtained in step a) with an r-amino(alkyl)ₐ-N-s(pyridine) for obtaining poly[r-(alkyl)ₐ-N-(pyridin-s-yl) (meth)-acrylamide moiety]_{m,n} derivatives linked by poly(dimethylsiloxane)ₚalkyl-(meth)-acrylate moiety derivatives;
complexation of the derivatives obtained in step b) by a transition metal cation in an organic solvent.

29. The method according to claim 28, wherein the (alkyloxy)-(meth)-acrylate moiety derivatives-poly(dimethylsiloxane)ₚ type compounds of step a), are exhibiting viscosity of from 50 to 90 cSt, having a Mn of from about 4000-5000, or 125-250 cSt, having a Mn of from about 8000 to 11 000.

30. The method according to claim 28, wherein the UV-initiated polymerization of step a) is carried out of from 2 to 5 min.

31. The method according to any of claim 28, wherein the amount of the active ester in the mixture is of from 45 wt % to 60 wt %, the amount of the poly(dimethylsiloxane)ₚ moieties in the mixture is of from 40 wt % to 55% wt %, the amount of an organic solvent, is of from 5 to 10 wt %.

32. The method according to claim 28, wherein the amount range of the r-amino(alkyl)a-N-s(pyridine) compound in the reaction medium of step b) is advantageously of from 1.5 molar eq. to 2.6 molar eq. based on the poly[(pentafluorylphenyl-(meth)acrylate moiety]_{m,n} derivatives linked by poly(dimethylsiloxane)ₚalkyl-(meth)acrylate moiety derivatives molar content.

33. The method according claim 28, wherein the amount of transition metal salt is in the range of from 0.03 M/L to 0.05 M/L.

34. A method for preparing a material coated on a substrate, the material comprising a metallo supramolecular polymer conetworks (MSMC) of poly[r(alkyl)ₐ-N-(pyridin-s-yl) (meth)-acrylamide moiety]_{m,n} derivatives complexed to a transition metal cation-linked by poly(dimethylsiloxane)ₚalkyl-(meth)-acrylate moiety derivatives, wherein a is 0 or 1 or 2, p is an integer selected from the group consisting of from 50 to 70 and of from 120 to 180, r is integer of from 0 to 4, and s is an integer of from 2 to 4, and m and n, independently, are integers of from 5 to 11, said method comprising the following of step of:
grafting s(trialkyloxy-silyl)alkyl(meth)-acrylate derivatives onto the substrate,
providing a reaction medium comprising a mixture of (alkyloxy)-(meth)-acrylate moiety derivatives-poly(dimethylsiloxane)ₚ type compounds wherein p is an integer selected from the group consisting of from 50 to 70 and of from 120 to 180, and an active ester comprising a pentafluorophenyl-(meth)-acrylate moiety and a photoinitiator, contacting said mixture with the functionalized substrate of step 1), performing an UV-initiated polymerization, for the obtention poly[(pentafluorophenyl-(meth)-acrylate moiety]m,n derivatives linked by poly(dimethylsiloxane)ₚalkyl-(meth)-acrylate moiety derivatives bound to the functionalized substrate;
reacting the poly[(pentafluorophenyl-(meth)-acrylate moiety]m,n linked by poly(dimethylsiloxane)ₚalkyl-(meth)-acrylate moiety derivatives which are bound to the functionalized substrate, with an r-amino(alkyl)a-N-s(pyridine) for obtaining poly[r-(alkyl)ₐ-N-(pyridin-s-yl) (meth)-acrylamide moiety]_{m,n} derivatives linked by poly(dimethylsiloxane)ₚalkyl-(meth)-acrylate moiety derivatives, bound to the functionalized substrate;
complexation of the derivatives obtained in step 3), which are bound to the functionalized substrate, by a transition metal cation in an organic solvent.

35. The method according to claim 34, wherein, in the step 1), the alkyl groups in s(trialkyloxy-silyl)alkyl(meth)-acrylate derivatives are selected from the group consisting of methyl, ethyl, propyl, butyl or mixtures thereof.

36. The method according to claim 34, wherein concentrations of s(trialkyloxy-silyl) alkyl(meth)acrylate derivatives of the step 1) in an organic solvent are comprised in a range of values of from 10 vol % to 30 vol %.

37. The method according to claim 36, wherein the (trialkyloxy-silyl)alkyl(meth)acrylate derivatives are selected from the group consisting of 1-(trimethoxysilyl)methylacrylate, 2-(trimethoxysilyl)ethylacrylate, 3-(trimethoxysilyl)propylacrylate, 1-(trimethoxysilyl)methylmethacrylate, 2-(trimethoxysilyl)ethylmethacrylate, 3-(trimethoxysilyl)propylmethacrylate 1-(triethoxysilyl)methylacrylate, 2-(triethoxysilyl)ethylacrylate, 3-(triethoxysilyl)propylacrylate, 1-(triethoxysilyl)methylmethacrylate, 2-(triethoxysilyl)ethylmethacrylate, 3-(triethoxysilyl)propylmethacrylate, or a mixture thereof.
